(19) United States
(12) Patent Application Publication
(10) Pub. No.: US 2015/0186955 A1
(43) Pub. Date: Jul. 2, 2015

(54) PhotoTour Referral Marketing Hyperlink

(71) Applicant: Steve Gaither, Santa Barbara, CA (US)

(72) Inventor: Steve Gaither, Santa Barbara, CA (US)

(21) Appl. No.: 14/576,189

(22) Filed: Dec. 18, 2014

Related U.S. Application Data
(60) Provisional application No. 61/921,003, filed on Dec. 26, 2013.

(51) Int. Cl. G06Q 30/02; H04L 12/58; G06Q 50/00; G06F 17/22

(52) U.S. Cl. CPC G06Q 30/0277; G06F 17/2235; G06F 17/2247; H04L 51/32; H04L 51/04; G06Q 50/01

(57) ABSTRACT

The present invention incorporates a Web-based software application or mobile App that generates a URL or hyperlink that, when clicked, opens a Web page (in the background) with a PhotoTour playing (in the foreground). It opens a ‘designated landing page’ that is ‘framed’ on the website; a PhotoTour that is floating, centered and sized to fit within the browser window; and redirects to the designated Web page when the PhotoTour is closed. It is a simple URL or hyperlink that is electronically transmitted via e-mail or text message or posted on a Web page or socially shared via buttons on a PhotoTour or posted on a social media site that can potentially drive a significant amount of word-of-mouth/referral traffic to a designated Website.

### RELATED APPLICATIONS

This application claims priority to U.S. Provisional Application Ser. No. 61/921,003, filed Dec. 26, 2013 and entitled “PhotoTour Referral Marketing Hyperlink.” The 61/921,003 application is hereby incorporated by reference in its entirety.

### BACKGROUND

1. Field of the Invention

The present invention relates generally to a method and system for a hyperlink. More specifically, the present invention is a Web-based software application that generates a URL or hyperlink that, when clicked, opens a Web page with a PhotoTour slideshow or video playing.

2. Description of Prior Art

Millions of people utilize the World Wide Web, the Internet and mobile Apps to conduct business. Many people browse Websites and use mobile Apps to view photos and videos as part of their buying process. Currently, there are no effective ways to display photographic images or video content AND drive traffic to a Website. It is therefore an object of the present invention to introduce a Web-based software application that generates a URL or hyperlink that, when clicked, opens a Web page with a PhotoTour slideshow or video playing and, when the PhotoTour is closed, redirects to a designated Web page.

There is still room for improvement within the art.

### SUMMARY OF THE INVENTION

The present invention relates to a Web-based software application that generates a URL or hyperlink that, when clicked, opens a Web page (in the background) with a PhotoTour slideshow or video playing (in the foreground).

The invention opens a ‘designated landing page’ that is initially ‘framed’ on the PhotoTours.com Website; opens a PhotoTour slideshow or video that is floating, centered and sized to fit within the browser window; and redirects to the designated Web page when the PhotoTour is closed.

What makes this marketing solution unique is that a simple URL or hyperlink that is socially shared via buttons on a PhotoTour or posted on a social media Website can potentially drive a significant amount of word-of-mouth/referral traffic to a designated Website (e.g., a destination marketing organization (DMO), hotel, restaurant or real estate Website). In the alternative, the same hyperlink or URL can be posted on a Web page, or electronically transmitted via e-mail or text message or placed in the address line of a Web browser.

The process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows a standard computing device;

FIG. 3 shows the flow of the invention;

FIG. 4 is a screenshot of the landing page of the present invention;

FIG. 5 is a screenshot of the PhotoTour of the present invention; and

FIG. 6 is a screenshot of the designated landing page of the present invention.

### DESCRIPTION OF THE PREFERRED EMBODIMENT

There are a number of significant design features and improvements incorporated within the invention. All illustrations of the drawings are for the purpose of describing selected versions of the present invention and are not intended to limit the scope of the present invention.

The present invention is a Web-based software application that generates a URL or hyperlink that, when clicked, opens a Web page with a PhotoTour slideshow or video playing. It relates to a data processing system 1 on which a Web-based software application runs that generates a URL or hyperlink that, when clicked, opens a designated Web page (in the background) with a PhotoTour slideshow or video playing (in the foreground). This technology is designed for any device that can access the Internet such as personal computers, laptops, smartphones, televisions and tablets as well as others.

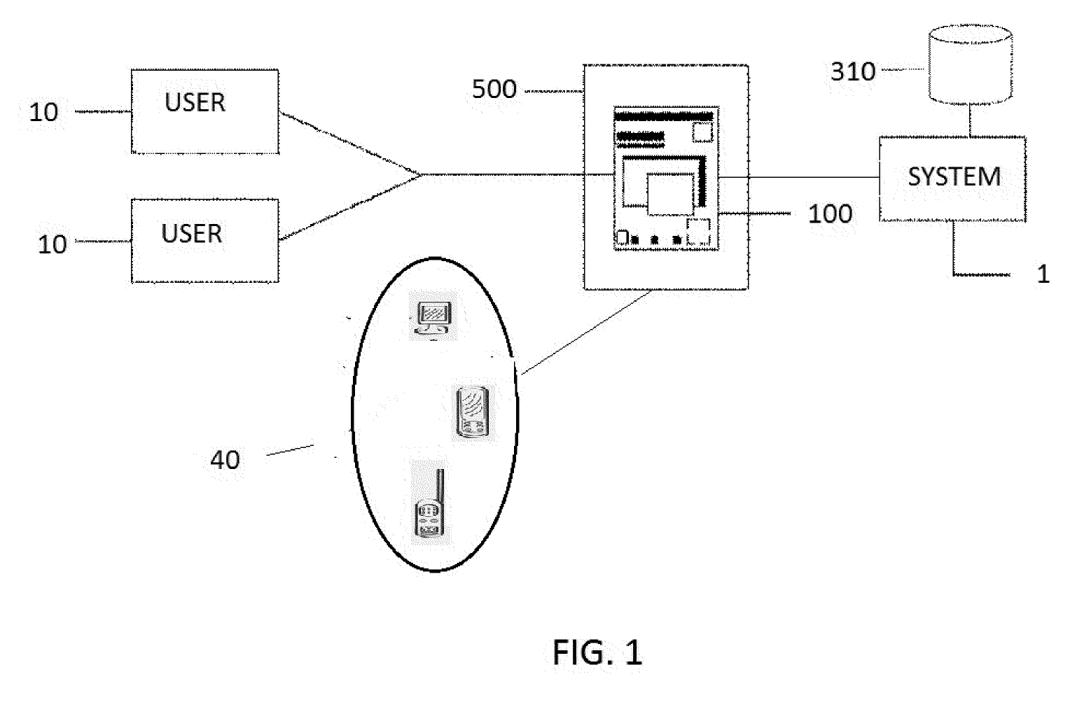

As shown in FIG. 1, users 10 would access the system 1 through a website or mobile application 100 by the Internet 500 or a direct connection. The system's software would reside in the system's server electronic memory 310. There are a number of different components of the system 1, these are described below. The system will also be accessible via devices such as PCs, smartphones, televisions, tablets and other similar devices 40.

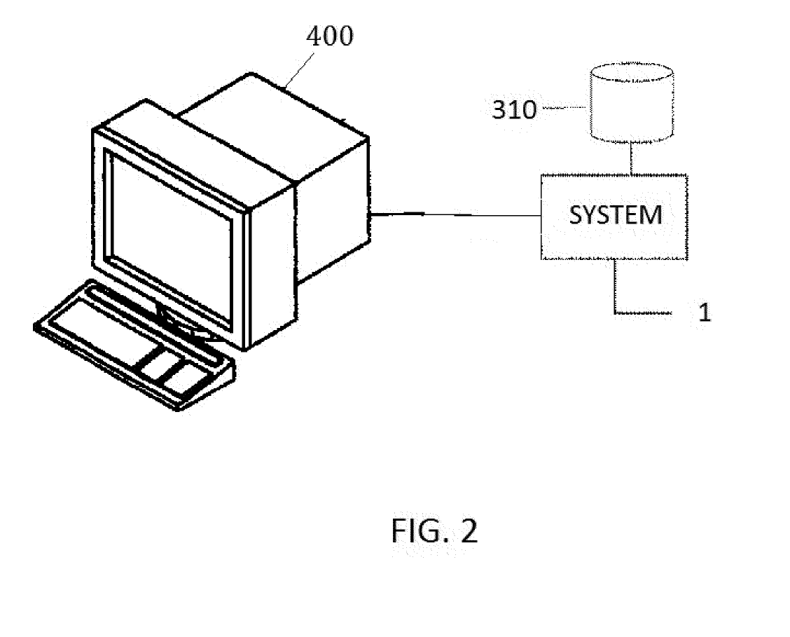

As shown in FIG. 2, the system 1 can be run as a program loaded into the memory of a web server 400 which can be a standard computer device. The system 1 is set to run on a web server 400 such as a computing device. A computing device on which the present invention can run would be comprised of a CPU, Hard Disk Drive, Keyboard, Monitor, CPU Main Memory and a portion of main memory where the system resides and executes. Any general purpose server with an appropriate amount of storage space is suitable for this purpose. Web servers 400 like this are well known in the art and are not pertinent to the invention. The system 1 can also be written in a number of different languages and run on a number of different operating systems and platforms.

The system 1 uses a memory means such as a standard hard drive or any other standard data storage device to store the data.

The system 1 is designed to work to assist in the marketing of a location or a property or products and services.

The present invention is a Web-based software application that generates a URL or hyperlink 125 that, when clicked, opens a designated Web page 50 (in the background) with a PhotoTour slideshow or video 120 playing (in the foreground). A PhotoTour 120 is a series of photographic images or video content displaying a location or a property or a product or service.

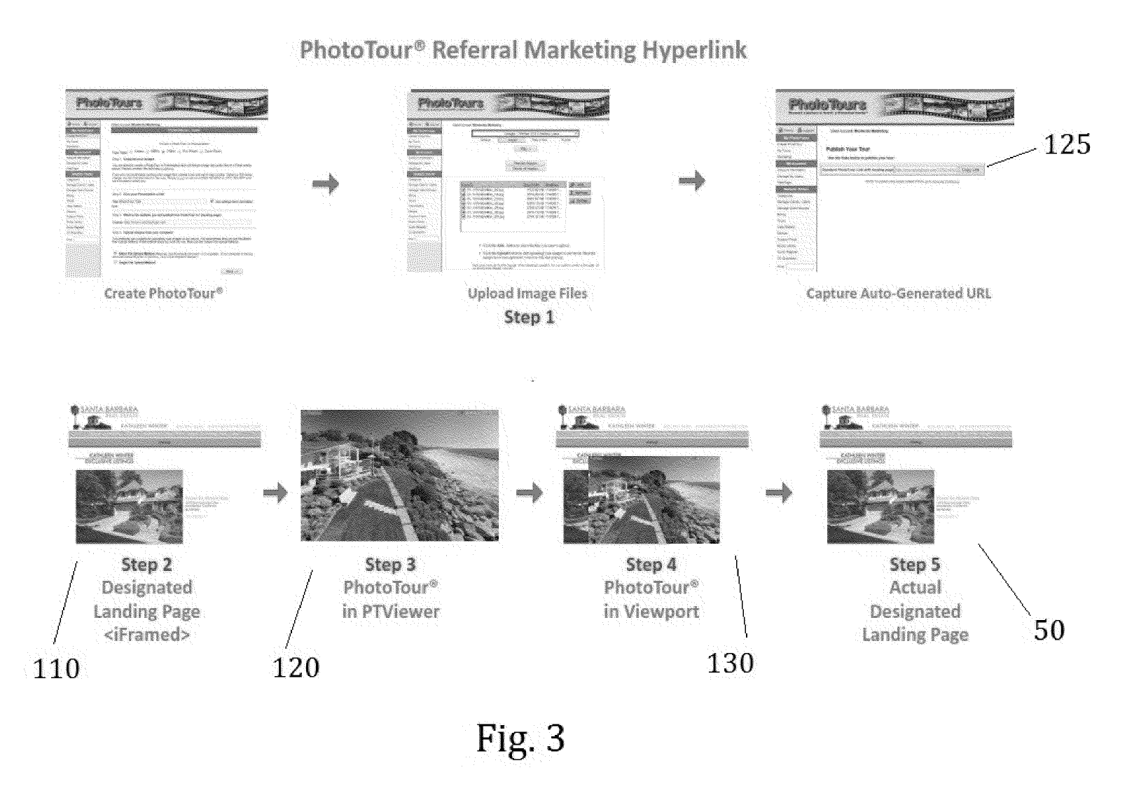

FIG. 3 shows the major steps of the system 1 which are:

Step 1: When a PhotoTour is created, a plurality of image files or video content is uploaded to the server 100, a “landing page” 110 is designated, PhotoTour settings are configured and a unique URL 125 is auto-generated (e.g., http://www.PhotoTours.com/?PTID=8738 or similar URL/link).

Step 2: This PhotoTour URL/link 125 can be electronically transmitted via e-mail or message or socially shared via buttons on a PhotoTour or posted on a social media Website or Web page and, when clicked, it opens or launches an HTML <iframe> element that displays the designated landing page 110 in the browser window.

Step 3: Once the HTML <iframed> element 125 loads, a JavaScript function inserts a hidden HTML <div> element. The hidden HTML <div> element, or PTViewer, contains the PhotoTour slideshow or video.

Step 4: Additional JavaScript makes the PhotoTour 120 visible, sized and playing in the center of the viewport. In other words, the PhotoTour 120 floats down from the top of the window, auto-sizes to approximately 85% of browser window's height and begins playing.

Step 5: When the PhotoTour “close button” is clicked, JavaScript is used to open or load the actual designated landing page in the browser window.

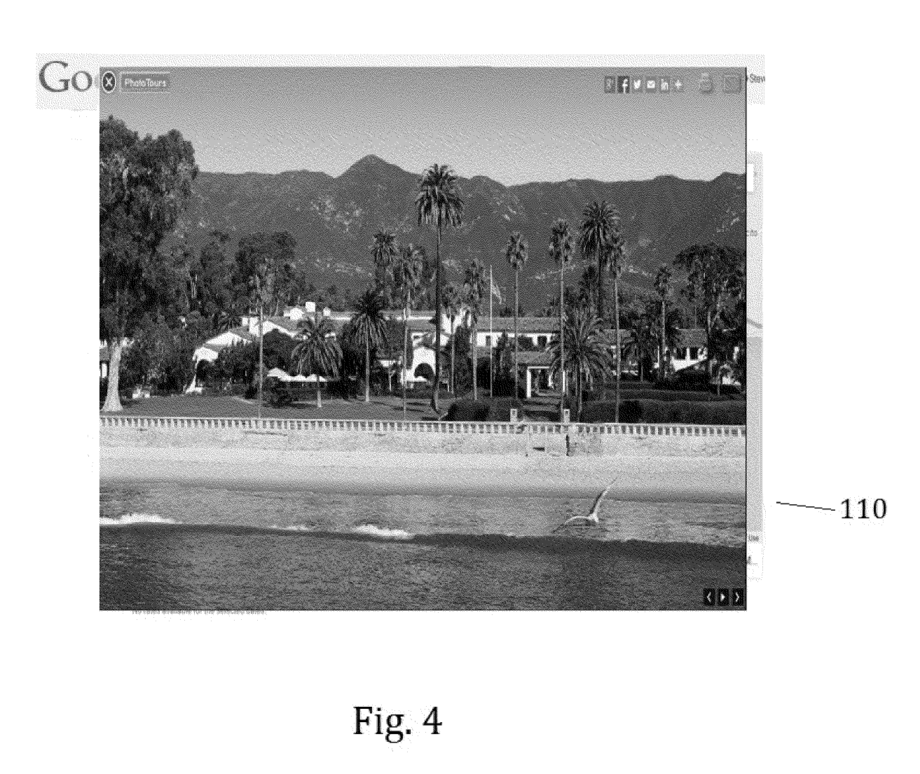

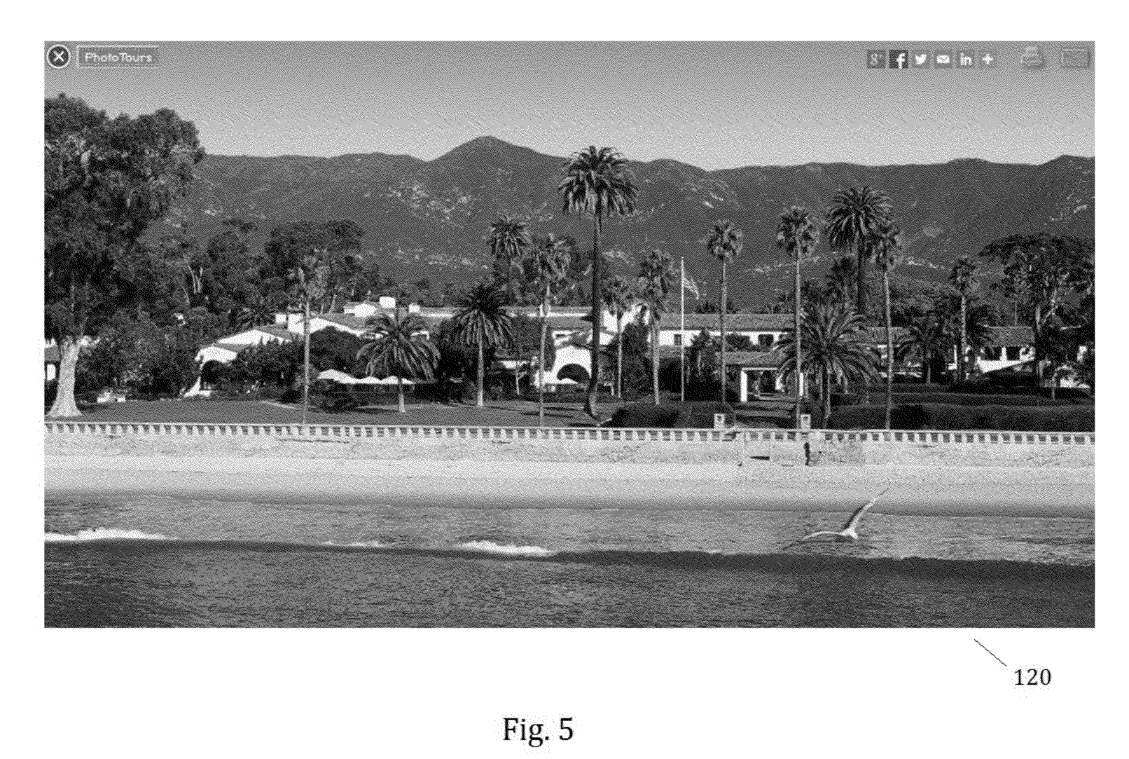

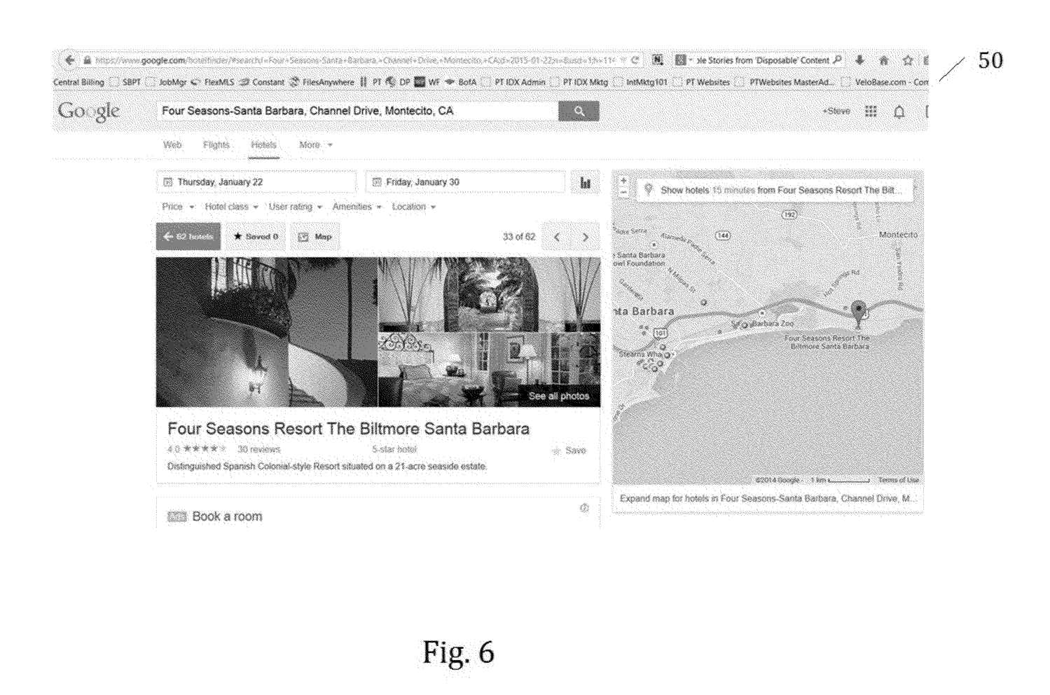

The following show what the software code does:
1. Opens a ‘designated landing page’ 110 that is ‘framed’ on the PhotoTours.com Website (FIG. 4—Framed Designated Landing Page);
2. Opens a PhotoTour slideshow or video 120 that is floating, centered and sized to fit within the browser window (FIG. 5—PhotoTour); and
3. Redirects to the designated Web page when the PhotoTour is closed (FIG. 6—Actual Designated Landing Page).

What makes this marketing solution unique is that a simple URL or hyperlink 125 that is socially shared via buttons on a PhotoTour or posted on a social media Website can potentially drive a significant amount of word-of-mouth/referral traffic to a designated Website 100 (e.g., a destination marketing organization (DMO), hotel, restaurant or real estate Website). In the alternative, the same hyperlink or URL 125 can be posted on a Web page or electronically transmitted via e-mail or text message or placed in the address line of a Web browser 130.

The following is an example of how the current invention works as shown in FIGS. 3 through 6.

A user 10 who is a real estate agent creates a PhotoTour using professional images (or video content) that is uploaded to showcase the features of their real estate listing. As part of the PhotoTour setup process, a ‘landing page’ 110 is designated to open in concert with the PhotoTour. When a Website visitor views the PhotoTour 120 and shares it with their social network (e.g., via buttons on a PhotoTour or electronically transmitted via e-mail or text message, or posted on Facebook, Twitter, Google+, LinkedIn, etc.), and their clients, colleagues, friends and/or family click the hyperlink 125 (e.g., http://www.phototours.com/?PTID=8738 or similar URL/link), the designated Web page 130 opens (in the background) with a PhotoTour 120 playing (in the foreground). When the PhotoTour 120 is closed (e.g., by clicking the X/close button), the person viewing the PhotoTour is redirected to the designated Web page 50.

The following is another example of how the system 1 may work.

A guest staying at a hotel or a visitor uses a mobile App on their smartphone or tablet to create a personalized or custom PhotoTour 120 with photos or video that they have taken with their camera, smartphone or tablet along with some geo-tagged digital assets (photos or video) 135 that have been made available by the hotel or place (e.g., restaurant, attraction, point of interest, etc.). When they share the PhotoTour with their social network (e.g., via buttons on a PhotoTour or electronically transmitted via e-mail or text message, or posted on Facebook, Twitter, Google+, LinkedIn, etc.), and their friends and family click the hyperlink 125 in their post (e.g., http://www.PhotoTours.com/?PTID=8731 or similar URL/link), the hotel or place's Web page 100 opens (in the background) with a PhotoTour 120 playing (in the foreground). Then, when the PhotoTour 120 is closed (e.g., by clicking the X/close button), the person who has been viewing the PhotoTour finds themselves redirected to the hotel or place's Website 100 and/or to a Web page 50 that possibly includes a booking/reservation feature.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising:
Processing on a processing unit with access to server software using electronic storage,
Generating a hyperlink that, when clicked, opens a designated Web page;
Opening a ‘designated landing page’ that is ‘framed’ on a Website;
Having the Web page playing a PhotoTour slideshow or video; and
Redirecting to a designated Web page when the PhotoTour is closed.

2. A system according to claim 1 further comprising;
Having the PhotoTour slideshow or video playing in the foreground.

3. A system according to claim 1 further comprising;
Fitting the PhotoTour that it is floating, centered and sized to a browser window;

4. A system according to claim 1 further comprising;
Posting a hyperlink on a social media site.

5. A system according to claim 1 further comprising;
Electronically transmitting a hyperlink via e-mail.

6. A system according to claim 1 further comprising;
Electronically transmitting a hyperlink via a text message.

7. A system according to claim 1 further comprising;
Posting a hyperlink on a Web page.

8. A system according to claim 1 further comprising;
Placing a hyperlink in the address line of a Web browser.

9. A system according to claim 1 further comprising;
Sharing a hyperlink via a button on a PhotoTour slideshow.

10. A system according to claim 1 further comprising;
Sharing a hyperlink via one or more buttons posted on a social media site.

11. A system according to claim 1 further comprising;
Sharing a hyperlink via one or more buttons posted on a web site.

12. A system according to claim 1 further comprising;
Autosizing the PhotoTour to 85 percent of a browser's height before playing.

13. A system according to claim 1 further comprising;
Having the PhotoTour being used for marketing.

14. A system according to claim 1 further comprising;
Having said system run on a server.

15. A system according to claim 1 further comprising;
Having said system run with an App.

16. A system according to claim 1 further comprising;
Having said designated web page being a reservation page.
